(19) United States
(12) Patent Application Publication
(10) Pub. No.: US 2006/0150787 A1
(43) Pub. Date: Jul. 13, 2006

(54) Young giant drywall screw counter sinker device

(76) Inventor: Nelson Young, Bronx, NY (US)

Correspondence Address: NELSON YOUNG, APARTMENT D8, 2766 BARNES AVE., BRONX, NY, 10467, US

(21) Appl. No.: 11/045,616

(22) Filed: Aug. 6, 2005

Related U.S. Application Data
(60) Provisional application No. 60/539,788, filed on Jan. 27, 2004.

(51) Int. Cl. B25B 23/08

(52) U.S. Cl. 81/451

(57) ABSTRACT

A. This Invention Claim Named “The Young Giant”, Is Related to A Screwdriving Device, For (1) the installation of Drywall Boards with included Interchangeable parts, engage during Actual Operation can Simultaneously insert Screws into Drywall Boards, And Countersink An Indentation that Surrounds the Screwheads. (2) The Installation of Wooden Materials, with included Interchangeable Parts, When engaged in Operation Can Simultaneously insert Screws into Wood, And Shave An Indentation that Surrounds the Screwheads. B. The Utility Tool Attachment, can Attach to any existing Standard Handheld Tool, Drills or Screwguns, filled with joint compound, C. There Are five Invented Prototypes, by The Inventor who has Developed Mostly with the use of Industrial Stationary Machinery, to ensure the Professional Accuracy, And Quality Safety, Comfort, Control, Stabilization, When engaged, to Move Freely in either direction, While And during Actual Operation of this Present Invention.

### CROSS-REFERENCE TO RELATED

This application claims the benefits of priority from provisional application patent number No 60/539,788, Filing date of Jan. 27, 2004

### BACKGROUND OF INVENTION

This invention is related to a screw guide device for the installation of drywall boards, and installing wooden materials, during the actual operation of this utility tool attachment, while attached to any standard hand tool, existing drills, or screwguns, simultaneously can insert the screws, and create a counter sink, an indentation into drywall boards, that surrounds installed screwheads, or inchangeable Rotating Wooden Shaving wheel that lock into position while engage, simultaneously screws and shave into the wood an indentation surrounds the screwheads.

### SUMMARY OF THE INVENTION

In accordance to the present invention, provides A Main controller Tubbier Rotary Embodiment that receives, in and out receiving related functioning connection parts, after assemble is completed can receive a variety of different diameter of screws, that sets into magnetic holder, for a tool bits at the frontend of driving shaft that rotated.

Including Two inserted Channel annular grooves at the Second Upper circumferance end of the aluminum drive shaft, including two E-clips in grooves, to embrace force pressure, when applied to the main controller interconnecting parts when engaged, and outerhouseing incasement remains stationary while engaging.

The further Safety Rubberized Coating on outer duplex housing incasement to provide needed safety, comfort and control, when inter rotatary main embodiment, further includes two installed ball bearings ring sets, first at front end, and second at the back end to stabilize and allows outerhouseing to move freely while engaging in operation, in either direction.

Further objectives and advantage of the invention, with A Outer provider, the collection of some standard tool parts, for the assembling of the force power to be released around the driving shaft, while rotating up and forces down through the interchamber hole of the main embodiment from the front end open to the back second end opening for connecting parts rotating will disengage, or engage, apply slight force pressure to handle of sective related hand tool

The primary objectives of this present invention is to provide A safe hand tool attachment, was mostly developed using stationary machinery to ensure its professional accuracy when engaged for safety control, stabilizing and comfort while moving freely in either direction.

For the easy installation of a variety of different diameter of drywall boards, and with interchangeable provided part screwed into a lock position, can thereafter engage to the installation of a variety of different diameter of wooden materials.

1. I claim As My Invention, Is The Entitled Named “The Young Giant”, Is related to a screw guide device for the installation of drywall boards, and installing wooden materials, during the actual operation of this utility tool attachment, while attached to ay variety of standard hand tool, existing drills, or screwguns, simultaneously when engage insert the screws, and create a counter sink, an indentation into Drywalls Boards, that surrounds installed screwheads, or inchangeable Rotating Wooden Shaving wheel that locks into position while engage, simultaneously screws and shave into the wood an indentation surrounds the screwheads.

2. IS A DEPENDENT claim OF claim 1, I claim As My Invention, the Interchangeable part Entitled Named “Indenter”, Like A Quarter Moon In Shape, With A Center Hole Opening to insert Interchangeable Screws that connects to Tool Bits into A Magnetic Holder on the First Front-End of the Plateform Head that Retracks, will enable a user to install Drywall Boards, when Simultaneously Counter-Sinking Drywall Screws and Creates an indentation surrounding the Screw heads, preventing hammering and damages to Drywall Boards.

3. IS A DEPENDENT claim OF claim 1, I claim As My Invention, the Interchangeable Part Entitled Named “Rotary” Wooden Shaving Wheels when screwed into lock position on the platform, and Interlocking with both Main Rotary Embodiment and Driving Shaft, that Slides into A claimed, included Metal Circular Displate, with A Outer Threaded Rim, And A Center Opening Shaped To Connect the Receiving Point of the tool Driving Shaft with Two Notch Indentation Grooves at the first front-end of the Metal Displate is Located at the Upper Male Threaded End of the nippled in the Interfemale threaded Chamber of the Rotary Wooden Shaving Wheel, As A hold unit, rotating enabling any user, when using Self-Tapping Screws, to Simultaneously Screw and Shave an Indentation into the Wood Surrounds the Screwheads.

4. IS A DEPENDENT claim OF claim 1, I claim As My Invention, The Entitled Named, Metal Circular Displate. include's A Outer Male-Threaded Rim, And A Center Opening shaped to connect the Recieving Point of A Tool Driving Shaft, At the Second-Upper Male-Threaded End Located in the Inter-Female Chamber of the Rotary Wooden Shaving Wheel.

5. IS A DEPENDENT claim OF claim 1, I claim As My Invention, The Entitled Named Circular Platform Head with A Center Female-Threaded open to A Interchamber for Connection of Tool And Interchangeable Screws, to screw in receiving functional parts.

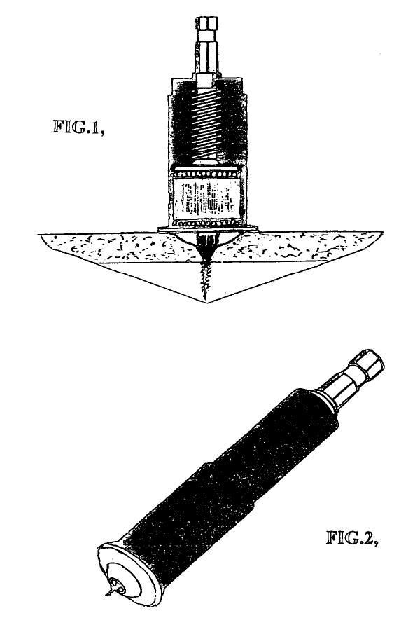

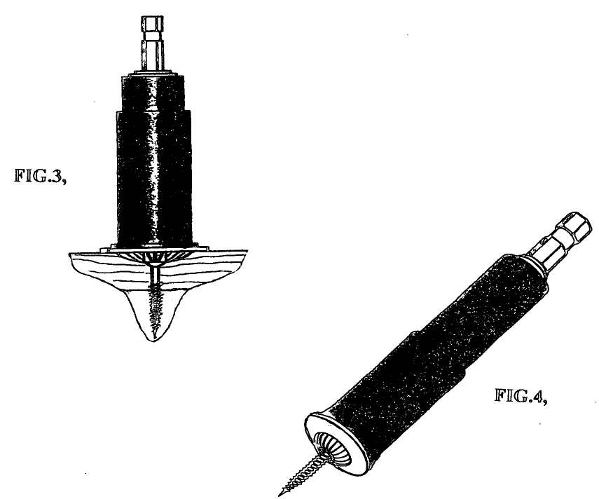

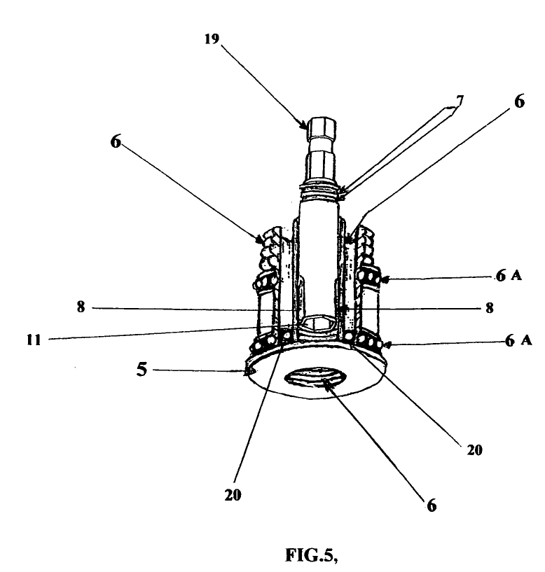

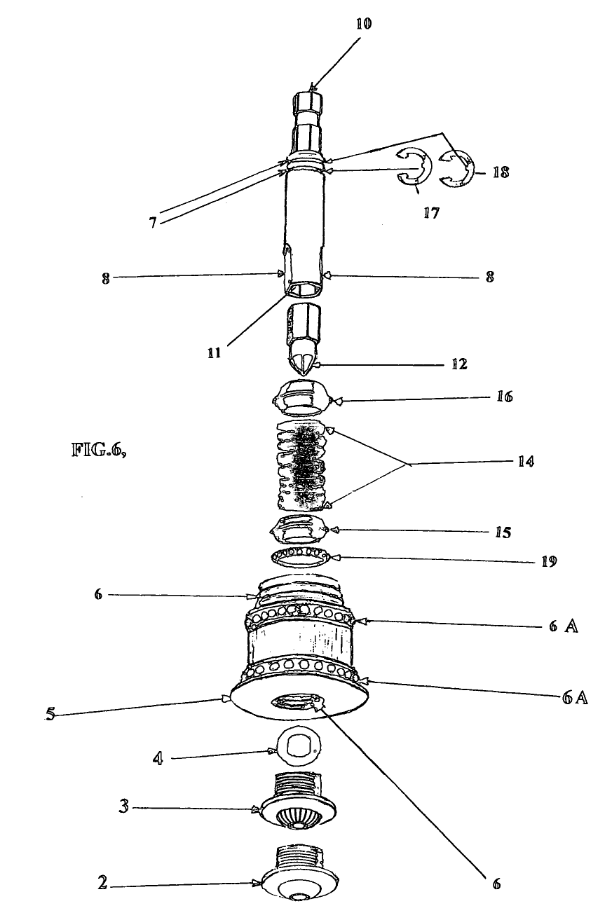

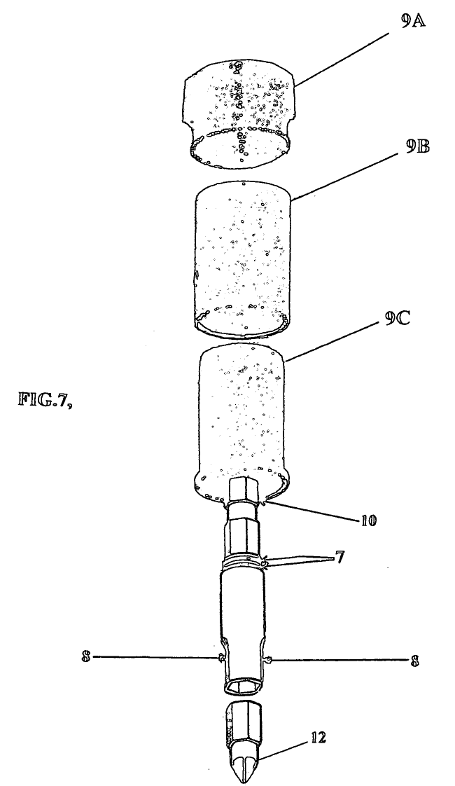

6. IS A DEPENDENT claim OF claim 1, I claim As My Invention, The Entitled Named Main Rotary Embodiment including A Platform Rim used as A Stopper, Including Center Opening with the first female threaded front-end to receive Interchangeable Tool Bits screws in and out, included claims parts FIG. 1. The Indenter and FIG. 2 Rotary Wooden Shaving Wheel, that lock into position. The Second back threaded end is A Connection Male-Threaded terminal, to Connect to other related functioning parts to operate in The Main Rotary Embodiment. Further claims includes Two Installed Ball Bearing Ring Set to Outer Embodiment, The First Ring Set at Front End, Second Ring Set to Back Upper End, with both 6 A installed allowed, the included Outer installed Tubbier Rubberized Coated Duplex Housing Incasement to Move Freely, in Either Direction, While “(Main Rotary Embodiment)” is Engaged in Operation,

7. IS A DEPENDENT claim OF claim 1, I claim As My Invention, “Two Channel Groove's, on A Standard Hand Tool Drive Shaft, at Upper End for Heavy Durability of receiving related functioning parts when engage included, (A) Two installed E-Clips at the Second-Upper End of the Aluminum Drive Shaft, into Both Channel Grooves to Embrace Force, when Applied.

8. IS A DEPENDENT claim OF claim 1, I claim As My Invention, “Two included Notches Shaped Indentations Out on the First Outer Front End of A Standard Aluminum Circular Hand Tool Drive Shaft, that Slides into A Open Related Connector, Included (As Claimed Above) that screws into Male-Threaded Outer Rim on A Metal Circular Displate In The Rotary Wooden Shaving Wheels.

9. IS A DEPENDENT claim OF claim 1, I claim As My Invention The Outer Tubbier Incasement with a Safety Rubberized Coating for Grips on top and bottom Duplex Housing, to provide Comfort' Stabilization, and Control with safety Covering And Functioning Parts, 9A, 9B, 9C.
